(19) United States
(12) Patent Application Publication
(10) Pub. No.: US 2025/0100738 A1
(43) Pub. Date: Mar. 27, 2025

(54) APPARATUS FOR LABELING CONTAINERS

(71) Applicant: KRONES AG, Neutraubling (DE)

(72) Inventors: Dieter HAFNER, Regensburg (DE); August PEUTL, Woerth a. d. Donau (DE); Martin WAGNER, Regensburg (DE)

(21) Appl. No.: 18/895,978

(22) Filed: Sep. 25, 2024

(30) Foreign Application Priority Data
Sep. 25, 2023 (DE) 10 2023 125 933.4

(51) Int. Cl. B65C 9/26; B25J 11/00; B25J 13/08; B25J 15/00; B25J 15/04; B65C 9/18

(52) U.S. Cl. CPC B65C 9/26; B25J 11/005; B25J 13/086; B25J 15/0047; B25J 15/04; B65C 9/18

(57) ABSTRACT

An apparatus for labeling containers. The apparatus has a labeling device with a labeling unit for labeling the containers and a supply device which is connected to the labeling unit for feeding a label tape to the labeling unit. The supply device has a robot cell which is arranged at a distance from the labeling unit. The robot cell has a roll storage unit, a roll receiving device, and a robot that is configured to automatically load the roll receiving device with label rolls from the roll storage unit.

### CROSS REFERENCE TO RELATED APPLICATIONS

This application claims the benefit under 35 U.S.C. § 119 (a) of German Patent Application No. DE 10 2023 125 933.4, filed Sep. 25, 2023 entitled APPARATUS FOR LABELING CONTAINERS, and whose entire disclosure is incorporated by reference herein.

### TECHNICAL FIELD

The invention relates to an apparatus for labeling containers, having a supply device for supplying a labeling device with a label tape for labeling containers.

### TECHNICAL BACKGROUND

A container treatment plant can comprise a labeling device for labeling containers. For example, the labeling device can label the containers with labels from a label roll (roll of label material).

Traditionally, the label rolls are refilled manually by an operator. The user may have to perform additional tasks, such as cutting the label tape to the correct position, applying double-sided adhesive tape to the label tape, or inserting the label tape into an automatic gluing.

DE 10 2021 125 133 A1 describes a mobile robot, a supply system, and a method for changing label rolls on a labeling unit for labeling containers. The mobile robot accordingly comprises a vehicle unit for changing locations of the robot and a manipulator unit with a multi-axle manipulator and an associated end effector for manipulating label rolls. Since the end effector is designed to grip the outer circumference of the label rolls and emptied roll cores of label rolls so as to carry them, ergonomically problematic work steps when refilling label rolls can be accomplished exclusively by machine with a high degree of precision and in a material-saving manner.

EP 3 760 550 A1 describes a transfer unit for feeding rolls of labeling material to a labeling module that is configured to apply labels to objects. The transfer unit includes a support element configured to support a plurality of rolls arranged vertically in at least one stack. The transfer unit further has a robot arm configured such that it removes at least one roll from the stack at a gripping station and releases it at a release station.

The invention is based on the object of providing an improved supplying a labeling device with labeling rolls.

### SUMMARY OF THE INVENTION

The object is achieved by the features of the independent claims. Advantageous developments are specified in the dependent claims and the description.

One aspect of the present disclosure relates to an apparatus for labeling containers (e.g., for a container processing plant). The apparatus has a labeling device, preferably a rotary labeling device, with a labeling unit for labeling the containers. The apparatus has a supply device which is connected to the labeling unit for feeding a label tape to the labeling unit. The supply device has a robot cell which is arranged at a distance from the labeling unit. The robot cell has a roll storage unit for storing label rolls. The robot cell further has a roll receiving device for receiving and unrolling at least one label roll to form the label tape for feeding to the labeling unit. The robot cell further has a robot (e.g., with or without collaboration functionality), preferably a multi-axis robot, particularly preferably an articulated arm robot. The robot is configured to automatically load the roll receiving device with label rolls from the roll storage unit.

On the one hand, the apparatus can advantageously enable a very high degree of automation. The robot can advantageously carry out as many tasks as possible, instead of specialized automated individual devices, which can result in particular in cost and flexibility advantages. On the other hand, the apparatus advantageously allows that accessibility to the labeling unit is not impaired by the robot, etc. due to the spaced arrangement. This means, for example, that maintenance or adjustment work on the labeling unit can be carried out without great effort and with very good accessibility. Advantageously, it is also not necessary, as in the prior art according to DE 10 2021 125 133 A1, to meticulously keep the region directly in front of the labeling unit clear in order to always be able to provide a parking space for the mobile robot. Advantageously, the robot cell can also enable high performance of the supply device, which can also supply more than one labeling device, for example. In this context, the robot cell enables, for example, the installation of several roll receiving devices since the space conditions there are not tight, as they are directly at the labeling unit.

In one embodiment, the supply device further has a label tape buffer which is connected to the roll receiving device for receiving the label tape from the roll receiving device and to the labeling unit for feeding the label tape to the labeling unit. The label tape buffer is designed to buffer the received label tape and to dispense the buffered label tape for feeding to the labeling unit. Preferably, the label tape buffer can be arranged inside or outside an optional protective housing of the robot cell. This makes it possible to ensure a continuous supply of label tape even, for example, during the joining together of two label tapes.

In a further embodiment, the apparatus further has a tape guide bridge which connects the supply device and the labeling unit for guiding the label tape to the labeling unit. Preferably, the tape guide bridge can be arranged outside an optional protective housing of the robot cell. Advantageously, the tape guide bridge can be used to easily supply the labeling unit arranged at a distance without blocking the walking or driving paths between the labeling unit and the supply device.

In one embodiment, the robot cell is at least far enough away from the labeling unit that the labeling unit can be decoupled from the labeling device and moved away (e.g., pushed away). Alternatively or additionally, a minimum distance between the robot cell and the labeling unit can be ≥1 m, ≥1.5 m, ≥2 m, ≥3 m, ≥4 m, or ≥5 m. Alternatively or additionally, a walking or driving path can run between the robot cell and the labeling unit.

In a further embodiment, the labeling device has a further labeling unit for labeling the containers. The supply device is connected to the additional labeling unit for feeding an additional label tape to the additional labeling unit. The robot cell is arranged at a distance from the further labeling unit and in addition has a further roll receiving device for receiving and unrolling at least one further label roll to form the further label tape for feeding to the further labeling unit. The robot is configured to automatically load the additional roll receiving device with label rolls from the roll storage unit. Advantageously, a single robot can thus supply several labeling units with label rolls. The robot cell makes it possible for the robot not to have to be moved between two labeling units, which is complex and time-consuming. Instead, the robot can advantageously ensure the supply of the labeling units from a single position. The robot cell can therefore enable a high overall performance of the supply device.

In a variant, at least one of the following is fulfilled:
the supply device has a further label tape buffer which is connected to the further roll receiving device for receiving the further label tape from the further roll receiving device and to the further labeling unit for feeding the further label tape to the further labeling unit, wherein the further label tape buffer is designed to buffer the received further label tape and to dispense the buffered further label tape for feeding to the further labeling unit;
the apparatus further has a further tape guide bridge which connects the supply device and the further labeling unit for guiding the further label tape to the further labeling unit;
the robot cell is at least far enough away from the further labeling unit that the further labeling unit can be decoupled from the labeling device and moved away (e.g., pushed away);
a minimum distance between the robot cell and the further labeling unit is ≥1 m, ≥1.5 m, ≥2 m, ≥3 m, ≥4 m, or ≥5 m; and
a running or travel path runs between the robot cell and the further labeling unit.

In a further embodiment, the roll receiving device and the further roll receiving device are each oriented towards the robot, preferably each radially with respect to a (e.g., stationary) base of the robot, and/or each equidistantly from the robot. Advantageously, the robot can thus perform essentially the same movement to load the roll receptacles, so that substantially a one-time programming for this robot movement is sufficient to load several roll receiving devices and also to cover several configurations of the robot cell (e.g., stationary robot, robot on a linear axis, variable position of the roll receptacles, different number of roll receptacles, etc.). If the robot is attached movably to a linear axis, for example, the robot base has a plurality of working positions and the distance and orientation of the roll receiving devices can therefore be variable within a certain range.

In one embodiment, the roll receiving device and/or the further roll receiving device (each) has two, preferably horizontally or vertically oriented, roll receptacles, preferably roll plates, and a connector which is designed to connect a tape end of a label roll from one of the two roll receptacles to a tape start of a label roll from the other of the two roll receptacles. Preferably, the robot can further be configured to feed the tape start to the connector and/or to apply an adhesive tape to the tape start. This can advantageously enable an uninterrupted supply of label tapes as well as a secure and quick connection of the label tapes. Advantageously, a horizontal orientation of the roll receptacles can facilitate loading by the robot.

In a further embodiment, the robot cell further has a protective housing which encloses the roll storage unit, the roll receiving device, and the robot. Alternatively or additionally, the robot cell further has a system for generating at least one signal curtain, preferably a light curtain or laser curtain, for delimiting the robot cell (e.g., on one side or on multiple sides), wherein the system is preferably designed to generate a signal curtain in front of the roll storage unit to make the roll storage unit accessible from outside the robot cell. Advantageously, the protective housing and/or the signal curtain can enable the robot to achieve very high speeds and dynamics, as there is no danger to people in the surrounding area. This means that the robot cell can be operated at a very high performance level, which can, for example, supply more than one labeling device. However, it is also possible, for example, to dispense with a protective housing and signal curtains altogether and to operate the robot as a collaborative industrial robot (cobot). A signal curtain can advantageously be used to simplify loading the roll storage unit with label rolls, for example using a pallet truck or an automated guided vehicle (AGV).

In one embodiment, the robot cell further has a tool changing station, which is preferably arranged within an optional protective housing of the robot cell. The robot is configured to perform an automatic tool change at the tool changing station. Optionally, the robot can be configured to carry out an automatic tool change between different handling tools at the tool changing station, preferably having at least one roll handling tool, preferably a roll inner gripper, for handling a label roll and/or at least one tape start handling tool for handling a tape start of a label roll. The robot can therefore advantageously use different gripper types and different grippers of the same type (e.g., different tape start grippers for low and high label rolls).

In a further embodiment, the robot is a stationary robot, or the robot is movable within the robot cell, preferably along a linear axis and/or in rail-guided fashion.

In one design variant, the roll receiving device can (also) be manually loaded with a label roll. Preferably, the robot cell may further have an (obstacle-free) personnel movement area situated between the roll storage unit and the roll receiving device for an operator to manually load the roll receiving device with a label roll (e.g., when the robot is defective, undergoing maintenance, or deactivated).

In one embodiment, the robot cell further has a (e.g., stationary or robot-borne) inspection device (e.g., having a camera, a capacitive sensor, and/or an ultrasonic sensor) which is arranged for example within the protective housing and/or is configured to test label rolls, preferably with respect to at least one of:
a winding direction,
a position and/or a state of a tape start;
a type,
a diameter,
a deviation from a specified roll parameter (e.g., label protrusion over core, dimensions, weight, etc.), and
damage.

In a further embodiment, the robot cell further has a label roll buffer for the intermediate storage of tested label rolls, which is preferably arranged within an optional protective housing of the robot cell. This makes it advantageous to temporarily store tested label rolls.

In one embodiment, the robot is configured to turn a label roll depending on a winding direction of the label roll previously detected by means of a testing device.

Advantageously, the robot can thus enable the label roll to be fed to the roll receiving device with the correct winding direction, without special measures having to be taken to ensure that the label rolls are already placed on the roll storage unit with the correct orientation.

In a further embodiment, the robot has an adhesive tape dispenser for dispensing an adhesive tape, preferably a double-sided one, for connecting label tapes. This makes it advantageous to use a single adhesive tape dispenser for several connectors of the roll receiving devices. This can be particularly advantageous in combination with several roll receiving devices that are arranged in a defined manner with respect to the robot, since the programming effort for the robot can then be substantially reduced.

In one embodiment, the robot cell further has a detection device (e.g., having the system for generating at least one signal curtain) configured to detect an intrusion of a user into the robot cell, and, when the intrusion is detected:
to stop (e.g., only) the robot or to change an operation of the robot over from an autonomous operating mode to a cooperative operating mode; and/or
to allow the roll receiving device to continue running.

Advantageously, when entering the cell, only the robot can be stopped or switched to a mode that is safe for the user. However, the roll support device(s) and, if applicable, the connectors can continue to be used without modifications, as they do not pose any danger to the operator. This means that there is no immediate interruption in production when entering the robot cell. Alternatively, the robot can be operated as a cobot, for example, which allows work to continue at a reduced robot speed for example even when the protective housing of the robot cell is open.

Preferably, the supply device can be of modular construction and/or the at least one roll receiving device and the robot each have their own control device. The modularity can advantageously make it possible to set up different supply devices with different levels of automation. Preferably, it can be that the robot cell does not have a central control cabinet. Instead, each component can have its own control device, which advantageously improves the modularity and simplifies subsequent modifications or retrofitting.

A further aspect of the present disclosure relates to a container treatment plant (e.g., for controlling the temperature, producing, cleaning, coating, testing, filling, closing, pasteurizing, labeling, printing, marking, laser marking, and/or packaging containers for liquid or pasty media, preferably beverages, liquid foods or products from the pharmaceutical or healthcare industry). The container processing plant can have the apparatus for labeling as disclosed herein.

For example, the containers can be realized as bottles, cans, canisters, cartons, vials, tubes, etc.

Preferably, the term “control device” can refer to an electronic system (e.g., embodied as a driver circuit or with microprocessor(s) and data memory) and/or a mechanical, pneumatic, and/or hydraulic controller which can take over control tasks and/or regulation tasks and/or processing tasks, depending on the design. Although the term “control” is used herein, this can also comprise or be understood as “regulate” or “feedback-control” and/or “process.”

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 shows a perspective view of an apparatus for labeling containers according to one exemplary embodiment of the present disclosure;

FIG. 2 schematically shows a plan view of a supply device for supplying a labeling device;

FIG. 3 shows a perspective view of a robot of the exemplary supply device;

FIG. 4 shows a perspective view of the exemplary robot with a different handling tool than in FIG. 3; and

FIG. 5 shows a plan view of a supply device for supplying a labeling device.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

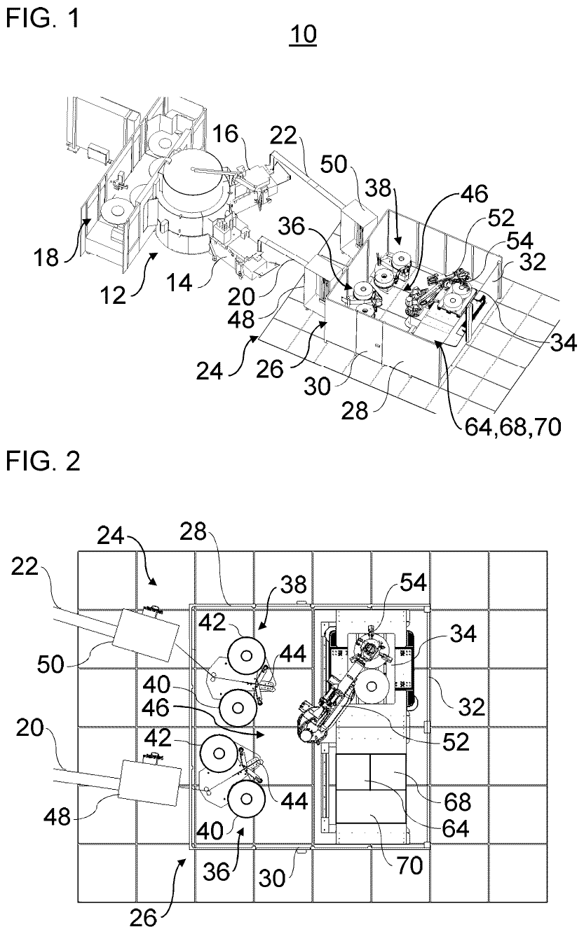

FIG. 1 shows an apparatus 10 for labeling containers. The apparatus 10 has a labeling device 12 and a supply device 24. The apparatus 10 can be comprised in a container treatment plant.

The labeling device 12 can label containers. For example, the labeling device 12 can have at least one labeling unit 14, 16. The at least one labeling unit 14, 16 can be designed to apply labels from a label tape to the containers.

The at least one labeling unit 14, 16 can be exchangeably capable of being coupled to and uncoupled from a periphery of the labeling device 12, e.g., via a preferably tool-free quick-coupling mechanism. Preferably, several labeling units 14, 16 are comprised, which are positioned at a distance from one another on the periphery. Preferably, the at least one labeling unit 14, 16 can have rollers for moving over a floor of the plant when uncoupled from the labeling device 12.

Preferably, the labeling device 12 can be a rotary labeling device. A drive of the labeling device 12 can rotate a rotatable carousel of the labeling device 12. Containers can be held and labeled at a distance from each other on a circumference of the carousel in treatment stations. Alternatively, the labeling device 12 can be designed, for example, as a linear labeling device, e.g., with only one treatment station or with several treatment stations arranged in a row next to one another and/or one behind the other.

Preferably, the labeling device 12 can be connected to at least one further container handling device by means of a container conveyor system 18. The container conveyor system 18 can, for example, have at least one transport star and/or at least one linear conveyor.

Preferably, the labeling device 12 can be connected to the supply device 24 via at least one (label) tape guide bridge 20, 22. A (unrolled) label tape can be fed from the supply device 24 to the labeling device 12 via the at least one tape guide bridge 20, 22.

In detail, the at least one labeling unit 14, 16 can be connected to the supply device 24 via the at least one tape guide bridge 20, 22. At least one label tape can be guided from the supply device 24 to the at least one labeling unit via the at least one tape guide bridge 20, 22. For example, a first labeling unit 14 can be connected to the supply device 24 via a first tape guide bridge 20. A second labeling unit 16 can be connected to the supply device 24 via a second tape guide bridge 22.

Preferably, the at least one tape guide bridge 20, 22 can run at a height that is higher than the at least one labeling unit 14, 16. When uncoupling and coupling the at least one labeling unit 14, 16, the at least one tape guide bridge 20, 22 can be driven under by the corresponding labeling unit 14, 16. It is also possible, for example, for a user to pass under the at least one tape guide bridge 20, 22 or for an automated guided vehicle (AGV) to pass under the at least one tape guide bridge 20, 22. For example, the at least one tape guide bridge 20, 22 can run at a height ≥1.50 m, ≥2.0 m, or ≥2.5 m.

Preferably, the at least one tape guide bridge 20, 22 runs substantially in a straight line between the corresponding labeling unit 14, 16 and the supply device 24.

The tape guide bridge 20, 22 can, for example, be tunnel-shaped or channel-shaped. Preferably, the tape guide bridge 20, 22 can have a sliding surface for the sliding supporting of a label tape, and/or lateral guide elements for laterally guiding the label tape.

The tape guide bridge 20, 22 can at least partially bridge a distance between the at least one labeling unit 14, 16 and the supply device 24. For example, the tape guide bridge 20, 22 can have a length in a range between 1 m and 10 m.

FIGS. 1 and 2 show the supply device 24. The supply device 24 supplies the labeling device 12 with at least one label tape for labeling containers. It is possible for the supply device 24 to supply at least one further labeling device with at least one further label tape for labeling containers.

The supply device 24 has a robot cell 26 with a roll storage unit 34, at least one roll receiving device 36, 38, and a robot 52. Optionally, the robot cell 26 can, for example, also have a protective housing 28, at least one label tape buffer 48, 50, a personnel movement area 46, a tool changing station 64, a testing device 68, and/or a label roll buffer 70.

The robot cell 26 is arranged at a distance from the at least one labeling unit 14, 16. Preferably, there can be sufficient space between the robot cell 26 and the at least one labeling unit 14, 16 for at least one person to be present and/or to enable the at least one labeling unit 14, 16 to be coupled and uncoupled. For example, a minimum distance between the robot cell 26 and the at least one labeling unit 14, 16 can be ≥1 m, ≥1.5 m, ≥2 m, ≥3 m, ≥4 m, or ≥5 m.

The (physical) protective housing 28 of the robot cell 26 can house the roll storage unit 34, the at least one roll receiving device 36, 38, and the robot 52, and optionally also the personnel movement area 46, the tool changing station 64, the testing device 68, and/or the label roll buffer 70. Preferably, the protective housing 28 completely encloses the roll storage unit 34, the at least one roll receiving device 36, 38, and the robot 52, as well as optionally the personnel movement area 46, the tool changing station 64, the testing device 68, and/or the label roll buffer 70. The robot cell 26 and/or the protective housing 28 can, for example, be rectangular/box-shaped.

The protective enclosure 28 can, for example, have a protective fence or a protective wall.

Preferably, the protective housing 28 can have at least one door 30 for entering the robot cell 26 or the protective housing 28. The door 30 can for example be integrated in the protective housing 28.

Preferably, the robot cell 26 can have a system 32 for generating at least one signal curtain. The signal curtain can be for example a light curtain or a laser curtain. A signal curtain can for example be arranged or generated in such a way that the roll storage unit 34 is accessible from outside the robot cell 26. Preferably, the signal curtain can be generated directly next to (in front of) the roll storage unit 34.

Preferably, the system 32 can generate at least one further signal curtain which is arranged so that the tool change station 64, the testing device 68, and/or the label roll buffer 70 are accessible from outside the robot cell 26. Preferably, the signal curtain can be generated directly next to (in front of) the tool changing station 64, the testing device 68, and/or the label roll buffer 70.

Intrusion into the robot cell 26 by a user can be detected by a detection device. For example, the system 32 can be part of the detection device. Alternatively or additionally, the detection device can, for example, monitor a closing state of the door 30. Alternatively or additionally, the detection device can, for example, carry out interior monitoring of the robot cell 26, preferably using a camera.

If the detection device detects an intrusion into the robot cell 26, the detection device can preferably only stop the robot 52 and allow other devices of the robot cell 26 to continue running, e.g., the at least one roll receiving device 36, 38 and optionally their connector 44. It is also possible for the detection device to change an operating mode of the robot 52 from an autonomous operating mode, in which the robot 52 loads the at least one roll receiving device 36, 38 fully autonomously and at high speed, etc., to a cooperative operating mode in which the robot 52 is operated as a cobot.

The roll storage unit 34 can be arranged inside the optional protective housing 28. For example, the roll storage unit 34 can be designed as a work table on which label rolls can be stored or a conveyor on which label rolls are stored. However, it is also possible, for example, for the roll storage unit 34 to be merely a pallet storage location for putting down a pallet loaded with label rolls or some other storage location for at least one label roll.

The roll storage unit 34 can, for example, be refilled with label rolls manually by a user, for example by means of a pallet truck or forklift. Alternatively or additionally, the label rolls can be refilled at the roll storage unit, for example automatically using an automated guided vehicle (AGV). Preferably, the roll storage unit can be reached by the user, the pallet truck, the forklift, and/or the automated guided vehicle through a signal curtain of the system 32.

The roll storage unit 34 can be arranged within a movement range of the robot 52. The robot 52 can pick up a label roll positioned on the roll storage unit 34.

The at least one roll receiving device 36, 38 can be arranged within the optional protective housing 28. The at least one roll receiving device 36, 38 is designed to receive at least one label roll and to unroll the at least one received label roll to form a label tape for feeding to the labeling device 12.

Preferably, several, e.g., two, roll receiving devices 36, 38 can be comprised. For example, a roll receiving device 36 can be connected to the labeling unit 14 for feeding a label tape to the labeling unit 14, e.g., via the tape guide bridge 20. A further roll receiving device 38 can be connected to the further labeling unit 16 for feeding a label tape to the further labeling unit 16, e.g., via the further tape guide bridge 22.

Preferably, the roll receiving devices 36, 38 can each be oriented towards the robot 52. Particularly preferably, the roll receiving devices 36, 38 can each be aligned radially with respect to a base of the robot 52 (shown in FIG. 2 only as an example for the roll receiving device 36). Alternatively or additionally, it is possible for example for the roll receiving devices 36, 38 to each be arranged equidistantly from the robot 52.

Preferably, a roll receiving device 36, 38 has in each case a first roll receptacle 40 and a second roll receptacle 42 and optionally a connector 44.

The roll receptacles 40, 42 can each hold a label roll, e.g., transferred by the robot 52.

The roll receptacles 40, 42 are preferably oriented horizontally. Alternatively, the roll receptacles 40, 42 can be oriented vertically, for example.

Preferably, the roll receptacles 40, 42 can be designed as so-called roll plates. Alternatively, the roll receptacles 40, 42 can be designed as drawers, for example.

The connector 44 can be designed to connect a tape end of a label roll on the roll receptacle 40 to a tape start of another label roll on the roll receptacle 42 (and vice versa).

The connector 44 can be designed as an adhesive connector, for example. The adhesive connector can bond the tape start and tape end together, e.g., by applying spray adhesive or by means of adhesive strips (adhesive tape). The adhesive strip is preferably a double-side adhesive strip. The adhesive strip can be applied, for example, by the connector 44 itself and can for example already be applied at the tape end or tape beginning, e.g., by the robot 52.

Alternatively, the connector 44 can be designed for example as a welding connector. The welding connector can weld the tape beginning and tape end together thermally or by means of ultrasound.

Preferably, the roll receptacles 40, 42 can be loaded with a label roll each not only by the robot 52, but also manually by a user. For this purpose, the user can for example be and move in a personnel movement area 46 provided specially for this purpose in the robot cell 26. It is also possible for the user to operate the connector 44, for example, from within the personnel movement area 46.

The personnel movement area 46 can preferably be arranged between the roll storage unit 34 and the at least one roll receiving device 36, 38. Preferably, the robot 52 is stopped (e.g., by the detection device) when a person is in the personnel movement area 46. Alternatively, the robot 52 can for example be operated such that it does not intervene in the personnel movement area 46 when a person is in the personnel movement area 46, or that it cooperates with a person in the personnel movement area 46 in a collaborative mode of operation.

The at least one label tape buffer 48, 50 is designed to receive and buffer a label tape from at least one of the roll receiving devices 36, 38 and to dispense the buffered label tape again. The dispensed label tape can be fed to the labeling device 12.

For example, a label tape buffer 48 can receive a label tape unrolled from the roll receiving device 36, buffer it and dispense it and feed it to the labeling unit 14, preferably via the tape guide bridge 20. A further label tape buffer 50 can receive a label tape unrolled from the further roll receiving device 36, buffer it and dispense it and feed it to the further labeling unit 16, preferably via the further tape guide bridge 22.

It is possible that the at least one label tape buffer 48, 50 is arranged inside or outside of the optional protective housing 28. Accordingly, the at least one label tape buffer 48, 50 may or may not be part of the robot cell 26.

The robot 52 can be arranged inside the optional protective housing 28. The robot 52 is designed to automatically load the at least one roll receiving device 36, 38 with label rolls from the roll storage unit 34. The robot 52 can load the at least one roll receiving device 36, 38, for example, directly from the roll storage unit 34. Alternatively, the robot 52 can load a label roll into the at least one roll receiving device 36, 38 only after testing and/or turning and/or intermediate storage.

Preferably, the robot 52 is a multi-axis robot, particularly preferably an articulated arm robot. The articulated arm robot can, for example, be a 5-axis, 6-axis, or 7-axis articulated arm robot. Other robot types are also conceivable.

The robot 52 may be an industrial robot without collaboration functionality. Alternatively, the robot 52 may be, for example, a collaborative industrial robot (cobot) that can collaborate with a user. For example, the robot 52 lifts and moves the label tapes to the at least one roll receiving device 36, 38 and a user operates the connector 44.

Preferably, a robot base of the robot 52 can be attached in the robot cell 26 in such a way that it can be easily exchanged or adapted by means of adapter plates. Preferably, in this way different robot types or manufacturers can be used. Preferably, it can be possible to exchange the robot 52 with simple handling devices, such as a pallet truck. For example, a (low-cost) robot 52 with a low payload can be used if only comparatively light label rolls are to be moved. If an upgrade to a robot 52 with a higher payload is desired, a simple conversion can be possible due to the design of the robot base. Preferably, a robot controller (control cabinet) is then designed in such a way that it does not have to be exchanged along with this.

Preferably, the robot 52 is arranged in stationary fashion in the robot cell 26. For example, the robot 52 can be arranged at a central position or in a central region within the robot cell 26, as shown in FIGS. 1 and 2.

However, it is also possible for the robot 52 to be movable within the robot cell 26, preferably along a linear axis and/or in rail-guided fashion. For example, a rail can run diagonally through the robot cell 26 or centrally between two opposite sides of the robot cell 26.

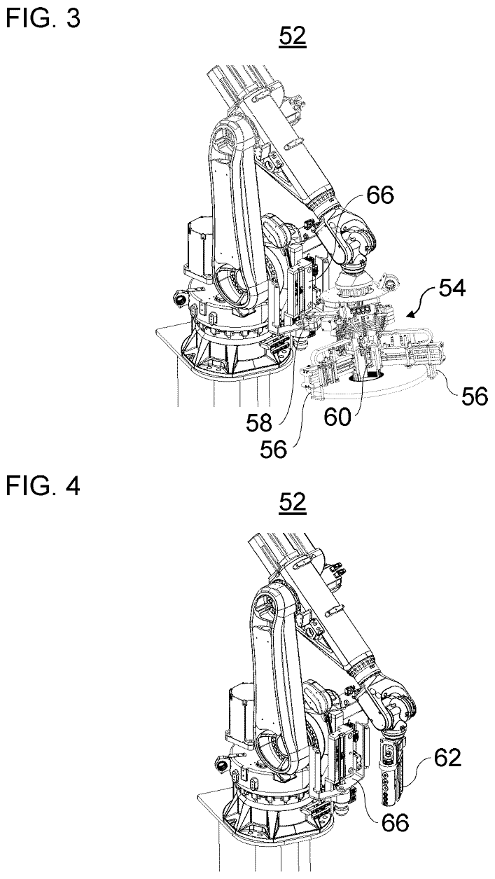

The robot 52 may include a roll handling tool 54 for handling a label roll (see also FIG. 3). The handling tool 54 can pick up and put down a label roll. The handling tool 54 can preferably be pneumatically driven.

The handling tool 54 can be structurally adapted to the roll receptacles 40, 42 so that the handling tool 54 can transfer a label roll to a corresponding roll receptacle 40, 42 as desired. For example, the handling tool 54 can be adapted to a corresponding clamping shaft of the roll receptacles 40, 42.

Preferably, the handling tool 54 is designed as a roll gripper. Preferably, the roll gripper is designed as an inner gripper, e.g., a centric gripper, for gripping the label roll at the roll core from the inside. In addition, the roll gripper can optionally have a clamping device 56. The clamping device 56 can secure the internally gripped label roll from the outside by lightly clamping it. Preferably, the clamping device can be used for label rolls that have a tendency towards telescoping, and/or to secure loose tape ends.

It is possible for the handling tool 54 or the robot 52 to have at least one sensor. For example, a camera 58 may be comprised for detecting a position of a label roll to be gripped, e.g., on the roll storage unit 34. Alternatively or additionally, for example, at least one distance sensor 60 for detecting a distance and/or an orientation of a label roll to be gripped or already gripped may be comprised.

Preferably, the sensor system of the robot 52 can also be used when commissioning the supply device 24, e.g., to determine a position of one or more components (e.g., roll storage unit 34; roll receiving device 36, 38; roll receptacles 40, 42, and/or connectors 44, etc.). This advantageously eliminates the need for laborious adjustment and calibration during commissioning.

Preferably, the robot 52 can be designed to turn a label roll by means of the handling tool 54. Preferably, the label roll can thus be turned if necessary so that a winding direction of the label roll corresponds to a desired winding direction for the at least one roll receiving device 36, 38.

Preferably, the robot 52 can automatically replace the roll handling tool 54 (see FIG. 3) with a tape start handling tool 62 (see FIG. 4) and vice versa. The robot 52 can have an automatic tool changing system, preferably a gripper changing system, for changing between the roll handling tool 54 and the tape start handling tool 62. It could also be possible to switch between different sizes and/or versions of the same gripper type, e.g., for easy retrofitting.

Preferably, the robot 52 can change the handling tools 54 and 62 at a tool changing station 64 (see FIGS. 1 and 2). The tool changing station 64 can be arranged within the optional protective housing 28. The handling tool 54 or 62 not currently being used by the robot 52 can be placed by the robot 52 at the tool changing station 64. Later, this deposited handling tool 54 or 62 can be picked up again by the robot 52 from the tool changing station 64, in exchange for the respective other handling tool 54 or 62.

However, it is also possible in principle for the robot 52 to carry both handling tools 54, 62 simultaneously, e.g., as a combination gripper (not shown in the figures).

The tape start handling tool 62 shown as an example in FIG. 4 is designed to handle a tape start of a label roll. With the handling tool 62, a tape start of a label roll, which is received in a roll receiving device 36, 38, can be guided to the connector 44.

Optionally, the handling tool 62 can cut a tape start of a label roll if, for example, the connector 44 does not have such a functionality.

Optionally, the handling tool 62 can apply an adhesive or an adhesive tape to a tape start of a label roll if, for example, the connector 44 does not have such functionality and the robot 52 does not have an adhesive tape dispenser.

Optionally, the handling tool 62 can detect cutting marks on the label tape if, for example, the connector 44 does not have an adhesive tape dispenser with such functionality.

The handling tool 62 is preferably designed as a tape gripper. For example, the handling tool 62 can have a bellows suction gripper or a clamping device for securely picking up the beginning of the tape.

It is possible for the handling tool 62 to have a device for receiving and disposing of the outer tape layer unwound from the label roll.

Preferably, the robot 52 can have an adhesive tape dispenser 66 (see FIGS. 3 and 4). The adhesive tape dispenser 66 can be designed to dispense an adhesive tape, preferably a double-sided one, for connecting label tapes.

For example, a tape start of a label roll received in a roll receiving device 36, 38 can be guided by the handling tool 62 to the adhesive tape dispenser 66 for applying the adhesive tape to the tape start. The adhesive tape can be applied in a precise position for example by aligning the beginning of the tape using the cutting marks of the label tape detected by cutting mark sensors of the adhesive tape dispenser 66.

The tape start thus treated can then be guided by the handling tool 62 to the connector 44, which connects the tape start to a tape end of another label roll that has been used up or has begun to be used.

Preferably, the adhesive tape dispenser 66 can be the only adhesive tape dispenser of the supply device 24. The adhesive tape from the adhesive tape dispenser 66 can thus be used for all connectors 44 or roll receiving devices 36, 38. Alternatively, for example, one adhesive tape dispenser can be comprised for each connector 44.

Referring again to FIGS. 1 and 2, it is shown that the testing device 68 can, for example, be a stationary testing device. Alternatively, the testing device 68 can be carried on the robot 52, for example.

The testing device 68 can be designed to test a label roll with respect to a winding direction, a position of a tape start, a state of a tape start (preliminary check of whether the tape start can be successfully picked up (so that a time-critical disturbance can be avoided later when changing the roll)), a type, a diameter, a deviation from a specified roll parameter (e.g., protrusion of labels over core, dimensions, weight, etc.) and/or damage.

The testing device 68 can have any suitable sensor technology for testing. For example, the testing device 68 can have a camera, a capacitive sensor, and/or an ultrasonic sensor.

Tested label rolls can then be placed for example by the robot 52 on a label roll buffer 70. From the label roll buffer 70, the robot 52 can load the at least one roll receiving device 36, 38 with tested label rolls.

The label roll buffer 70 can be arranged within the optional protective housing 28. For example, the label roll buffer 70 can be designed as a work table on which the tested label rolls can be placed. However, it is also possible, for example, for the label roll buffer 70 to be merely a pallet storage location for putting down a pallet loaded with label rolls, or some other storage location for at least one label roll.

Particularly preferably, the supply device 24 can be of modular construction.

For example, the tape guide bridge 20 and/or 22 can be constructed from several bridge segment modules. The protective housing 28 can be constructed from several wall modules. The roll storage unit 34 can for example be designed as a pallet storage module for a pallet truck and/or as a pallet storage module for an automated guided vehicle. The at least one roll receiving device 36, 38 can be a module in each case. The at least one label tape buffer 48, 50 can be a module in each case. The robot 52 can be a module. The tool changing station 64, the adhesive tape dispenser 66, the testing device 68, and/or the label roll buffer 70 can each be a module.

Preferably, each module can have its own control device. The control devices of the modules can be distributed accordingly in the robot cell 26.

A preferred method for supplying the labeling device 12 may, for example, have one, several, or all of the following method steps.

The robot 52 can pick up a label roll from the roll storage unit 34 using the roll handling tool 54. The robot 52 can move the label roll to the testing device 68. The label roll can be tested by the testing device 68. For example, the testing device can detect a tape start of the label roll and/or a winding direction of the label roll. If necessary, the label roll can be turned by the robot 52 using the roll handling tool 54 if the detected winding direction does not correspond to the desired winding direction. The tested and, if necessary, turned label roll can be placed on the label roll buffer 70 by the robot 52 by means of the roll handling tool 54 with the tape start preferably oriented as desired. The robot 52 can repeat the previous steps until the label roll buffer 70 is sufficiently filled.

If necessary, the robot 52 can remove an empty or opened label roll from one of the roll receptacles 40, 42. The roll core can be disposed of. An opened roll of labels can be stored in a separate place.

The robot 52 can, by means of the roll handling tool 54, place a new label roll, e.g., from the label roll buffer 70, onto one of the roll receptacles 40, 42, preferably with a desired orientation of the tape start.

The robot 52 can change from the roll handling tool 54 to the tape start handling tool 62, e.g., at the tool changing station 64. The tape start of the label roll can be picked up using the tape start handling tool 62. If necessary, the outermost layer of label tape can be unwound from the label roll and picked up by the tape start handling tool 62. The picked-up tape start can be fed by the robot 52 to the adhesive tape dispenser 66 by means of the tape start handling tool 62. At the adhesive tape dispenser 66, by means of a cutting mark detection system the correct location on the label tape for applying the adhesive strip can be determined, and the strip can be applied. The robot 52 can move the tape start thus treated to the connector 44 by means of the tape start handling tool 62. The label tape can be cut by the connector 44 or the tape start handling tool 62 and transferred by the tape start handling tool 62 to the connector 44. The robot 52 can dispose of the remaining label tape still located on the tape start handling tool 62. The robot 52 can switch from the tape start handling tool 62 back to the roll handling tool 54, e.g., at the tool changing station 64.

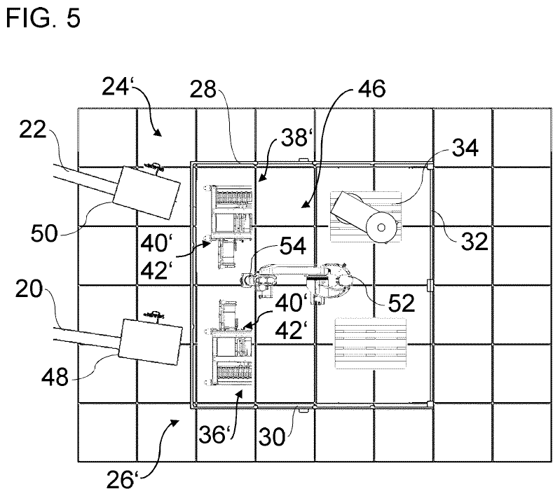

FIG. 5 shows modified supply device 24′.

For example, the roll receptacles 40′, 42′ of the roll receiving devices 36′, 38′ can be oriented vertically. More than two roll receptacles 40′, 42′ can also be comprised per roll receiving device 36′, 38′. Preferably, the roll receptacles 40′, 42′ are designed as drawers. For example, each roll receiving device 36′, 38′ can have its own adhesive tape dispenser.

The robot 52 can load one of the roll receptacles 40′, 42′ with a label roll. The robot 52 or another device can pick up the tape start of this label roll and place it in a holding device on the roll receiving device 36′, 38′. The adhesive tape can be applied without the intervention of the robot 52 by means of a device on the corresponding roll receiving device 36′, 38′ and on the adhesive tape dispenser. The bonding can again be done using a connector.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or the configuration of the labeling device, labeling unit, supply device, robot cell, roll storage unit, roll receiving device, and/or robot of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10 Apparatus for labeling containers
12 Labeling device
14 Labeling unit
16 Labeling unit
18 Container conveyor system
20 Tape guide bridge
22 Tape guide bridge
24 Feeding device
26 Robot cell
28 Protective housing
30 Door
32 System for generating a signal curtain
34 Roll storage unit
36 Roll receiving device
38 Roll receiving device
40 Roll receptacle
42 Roll receptacle
44 Connectors
46 Personnel movement area
48 Label tape buffer
50 Label tape buffer
52 Robot
54 Roll handling tool
56 Clamping device
58 Camera
60 Distance sensor
62 Tape start handling tool
64 Tool changing station
66 Adhesive tape dispenser
68 Testing device
70 Label roll buffer

What is claimed is:

1. An apparatus for labeling containers, having:
a labeling device with a labeling unit for labeling the containers; and
a supply device connected to the labeling unit for feeding a label tape to the labeling unit,
wherein the supply device has a robot cell which is arranged at a distance from the labeling unit and has:
a roll storage unit for storing label rolls;
a roll receiving device for receiving and unrolling at least one label roll to form the label tape for feeding to the labeling unit;
a robot configured to automatically load the roll receiving device with label rolls from the roll storage unit.

2. The apparatus according to claim 1, wherein;
the labeling device includes a rotary labeling device,
the robot is at least one of a multi-axis robot and an articulated arm robot,
the robot is movable within the robot cell, and
the robot cell includes a testing device configured to test label rolls.

3. The apparatus according to claim 1, wherein the supply device further has:
a label tape buffer connected to the roll receiving device for receiving the label tape from the roll receiving device and to the labeling unit for feeding the label tape to the labeling unit,
wherein the label tape buffer is designed to buffer the received label tape and to dispense the buffered label tape for feeding to the labeling unit.

4. The apparatus according to claim 1, further having:
a tape guide bridge which connects the supply device and the labeling unit for guiding the label tape to the labeling unit.

5. The apparatus according to claim 1, wherein at least one of:
the robot cell is spaced at least far enough from the labeling unit that the labeling unit can be uncoupled from the labeling device and moved away;
a minimum distance between the robot cell and the labeling unit is ≥1 m; and
a running or travel path runs between the robot cell and the labeling unit.

6. The apparatus according to claim 1, wherein:
the labeling device has a further labeling unit for labeling the containers;
the supply device is connected to the further labeling unit for feeding a further label tape to the further labeling unit;
the robot cell is arranged at a distance from the further labeling unit and further has a further roll receiving device for receiving and unrolling at least one further label roll to form the further label tape for feeding to the further labeling unit; and
the robot is configured to automatically load the further roll receiving device with label rolls from the roll storage unit.

7. The apparatus according to claim 5, wherein at least one of the following is fulfilled:
the supply device has a further label tape buffer which is connected to the further roll receiving device for receiving the further label tape from the further roll receiving device and to the further labeling unit for feeding the further label tape to the further labeling unit, wherein the further label tape buffer is designed to buffer the received further label tape and to dispense the buffered further label tape for feeding to the further labeling unit;
the apparatus further has a further tape guide bridge which connects the supply device and the further labeling unit for guiding the further label tape to the further labeling unit;
the robot cell is at least far enough away from the further labeling unit that the further labeling unit can be uncoupled from the labeling device and moved away;
a minimum distance between the robot cell and the further labeling unit is ≥1 m; and
a running or travel path runs between the robot cell and the further labeling unit.

8. The apparatus according to claim 5, wherein:
the roll receiving device and the further roll receiving device are at least one of each oriented towards the robot and are each arranged equidistantly from the robot.

9. The apparatus according to claim 8, wherein the roll receiving device and the further roll receiving device are at least one of each oriented radially towards the robot with respect to a base of the robot.

10. The apparatus according to claim 5, wherein:
at least one of the roll receiving device and the further roll receiving device has:
two roll receptacles; and
a connector adapted to connect a tape end of a label roll from one of the two roll receptacles to a tape start of a label roll from the other of the two roll receptacles.

11. The apparatus according to claim 10, wherein at least one of:
at least one of the roll receiving device and the further roll receiving device has two roll receptacles that are one of horizontally and vertically oriented,
at least one of the roll receiving device and the further roll receiving device has two roll plates, and
the robot is further configured to at least one of feed the tape start to the connector and to apply an adhesive tape to the tape start.

12. The apparatus according to claim 1, wherein the robot cell further has at least one of:
a protective housing which encloses the roll storage unit, the roll receiving device and the robot; and
a system for generating at least one signal curtain for delimiting the robot cell.

13. The apparatus according to claim 12, wherein at least one of:
the system is for generating one of at least one light curtain and at least one laser curtain, and
the system is designed to generate a signal curtain in front of the roll storage unit for making the roll storage unit accessible from outside the robot cell.

14. The apparatus according to claim 1, wherein the robot cell further has:
a tool changing station,
wherein:
the robot is configured to perform an automatic tool change at the tool change station.

15. The apparatus according to claim 1, wherein one of:
the robot is a stationary robot; and
the robot is movable within the robot cell at least one of along a linear axis and in rail-guided fashion.

16. The apparatus according to claim 1, wherein:
the roll receiving device can be manually loaded with a label roll; and
the robot cell further has a personnel movement area arranged between the roll storage unit and the roll receiving device for an operator to manually load the roll receiving device with a label roll.

17. The apparatus according to claim 1, wherein the robot cell further has:
a testing device configured to test label rolls with respect to at least one of:
a winding direction,
at least one of a position and a state of a tape start;
a type,
a diameter,
a deviation from a specified roll parameter,
damage, and
a label roll buffer for the intermediate storage of tested label rolls.

18. The apparatus according to claim 1, wherein at least one of:
the robot is configured to turn a label roll depending on a winding direction of one of the label roll previously detected via a testing device; and
the robot has an adhesive tape dispenser for dispensing an adhesive tape for connecting label tapes.

19. The apparatus according to claim 1, wherein at least one of;
the robot is configured to carry out an automatic tool change between different handling tools at a tool changing station within the robot cell, the different handling tools having at least one roll handling tool for handling at least one of a label roll and at least one tape start handling tool;
the robot is configured to carry out an automatic tool change between different handling tools at a tool changing station within the robot cell, the different handling tools having at least one roll inner gripper; and
the robot has an adhesive tape dispenser for dispensing a double-sided adhesive tape for connecting label tapes.

20. The apparatus according to claim 1, wherein the robot cell further has:
a detection device configured to detect an intrusion of a user into the robot cell, and when the intrusion is detected:
to stop the robot or to change an operation of the robot from an autonomous operating mode to a cooperative operating mode; and
to allow the roll receiving device to continue running.
